(19) United States
(12) Patent Application Publication
(10) Pub. No.: US 2005/0156578 A1
(43) Pub. Date: Jul. 21, 2005

(54) System and method for detecting a reversed battery cell in a battery pack

(75) Inventor: Robert Kamenoff, Port Orange, FL (US)

Correspondence Address: RICHARD K. WARTHER;ALLEN, DYER,DOPPELT,MILBRATH & GILCHRIST P.A., 1401 CITRUS CENTER 255 SOUTH ORANGE AVENUE, P.O. BOX 3791, ORLANDO, FL, 32802-3791, US

(73) Assignee: MATHEWS ASSOCIATES, INC., Sanford, FL (US)

(21) Appl. No.: 11/038,942

(22) Filed: Jan. 19, 2005

Related U.S. Application Data
(60) Provisional application No. 60/537,666, filed on Jan. 20, 2004.

(51) Int. Cl. H02J 7/00

(52) U.S. Cl. 320/165

(57) ABSTRACT

A system and method for detecting a reversed battery cell within a battery pack includes battery cells connected together and forming a battery pack and battery output. A transistor circuit is operatively connected to the battery cells and operative for determining when a voltage condition occurs indicative of a reversed battery cell within the battery pack. An indication circuit is operatively connected to the transistor circuit for indicating a reversed battery cell in the battery pack.

### RELATED APPLICATION

This application is based upon prior filed copending provisional application Ser. No. 60/537,666 filed Jan. 20, 2004.

### FIELD OF THE INVENTION

This invention relates to batteries, and more particularly, the present invention relates to a system and method for detecting a reversed battery cell in a battery pack.

### BACKGROUND OF THE INVENTION

Industrial batteries used in civilian and military applications often require large numbers of rechargeable batteries, such as lithium batteries. Often smaller batteries are arranged together to form a larger battery pack, which could include primary and secondary batteries. Often the voltage requirements are met by stacking series connected battery cells and adding parallel strings of battery cells to meet the voltage requirements and/or any necessary cut-off voltage.

In any event, associated problems with industrial and similar battery packs exist. For example, in order to meet battery pack size and performance requirements, it is often necessary to arrange battery cells in a series/parallel arrangement. In the case of primary battery cells, it is necessary to include a series diode in each series string to isolate the strings from each other and prevent charging of the battery cells. A potential problem exists if one or more battery cells in any one string are inadvertently installed backwards, i.e., reversed. That battery cell or cells would be charged by the discharge current of the other battery cells in that string, possibly leading to catastrophic failure of the reversed battery cell(s). A system and method of detecting any reversed battery cells in a battery pack is therefore required. It would also be advantageous if faulty battery cells could be detected.

Prior art proposals for detecting series/parallel connected battery cells in battery packs for any reversed battery cells have used visual inspection or a battery terminal voltage test to detect a reversed cell. Visual inspection is typically only about 75% effective. A simple terminal voltage test of a battery cell usually is not reliable. Because of the protection diodes in each series string, the battery terminal voltage will be equal to the voltage of the highest string.

Other proposals for detecting reversed battery cells in battery charging systems are not as applicable to battery packs. For example, different systems are disclosed in U.S. Pat. Nos. 6,043,625; 6,583,601; 6,724,593; and published U.S. patent application no. 2002/0053895. A protection system for a battery having a switching mechanism is disclosed in U.S. Pat. No. 6,646,845. Although these systems provide some reversed battery cell detection in a battery charger or similar systems, they have not been wholly adequate for a battery pack with a number of battery cells in which one battery cell could be reversed causing problems for the entire battery pack. Other battery packs may use only a series string of battery cells and may not include protection diodes configured as in a series/parallel battery pack. This change may require modifications in a reversed cell detection system and method.

### SUMMARY OF THE INVENTION

It is therefore an object of the present invention to provide a battery pack formed from a number of cells in series and/or series/parallel configuration that allows the detection of a reversed battery cell.

It is also an object of the present invention to provide a system and method that detects faulty and reversed battery cells.

A system and method of the present invention detects a reversed battery cell within a battery pack. A plurality of battery cells are connected together and form a battery pack having a battery output. A transistor circuit is operatively connected to the battery cells and operative for determining when a voltage condition occurs indicative of a reversed battery cell within the battery pack. An indication circuit is operatively connected to the transistor circuit for indicating the reversed battery cell condition. The transistor circuit could be formed as a plurality of transistors each having a drain connected to the indicator circuit, a source connected to the battery output, and a gate operatively connected to the battery cells. The indication circuit could be a light emitting diode to provide a visual indication of a reversed battery cell or a power switch circuit that disconnects a series string or the entire battery pack from the battery output.

In one aspect of the invention, the transistors are Field Effect Transistors and each transistor source is tied to the battery output and each transistor gate is tied to the series string voltage before the diode. The transistor drains are tied together and drive a LED. If any series string voltage is lower than the battery output by a volt or so, as would be the case with a reversed battery cell, that transistor turns on and lights the LED. The lit LED is clearly visible during manufacturing, especially at the final assembly stage where the battery pack is being closed or placed into its case. This alerts the operator to the problem.

The power switch circuit can use a transistor, for example, a Field Effect Transistor (FET), in each series cell string. Each transistor source is tied to the battery output and each transistor gate is tied to the series string voltage before the diode. The transistor drains are tied together and drive an additional FET in the battery output. If any series string voltage is lower than the battery output by about a volt, as would be the case with a reversed cell, that transistor turns on and turns off the additional FET disconnecting the battery from the output terminal.

In yet another aspect of the preset invention, instead of placing an FET in the battery output, an FET could be placed in each series cell string. In the event of a reversed battery cell, only the series string that contains the reversed battery cell would be disconnected, allowing the remaining series strings to deliver power to the load.

The LED circuit could also be used in conjunction with the power switch circuit to provide a visual indication of the reversed cell during manufacturing of the battery pack. This approach prevents the battery pack from being discharged when a cell is reversed thereby preventing the reversed cell from being charged during battery discharge.

In yet another aspect of the present invention, the battery pack includes a series string of cells and voltage dividers connected in parallel thereto. The voltage divider is of such ratio that the divided voltage is equal to the voltage at a point in the series string of cells when a cell is connected properly.

### BRIEF DESCRIPTION OF THE DRAWINGS

Other objects, features and advantages of the present invention will become apparent from the detailed description of the invention which follows, when considered in light of the accompanying drawings in which:

FIG. 1 is a fragmentary, sectional view of one example of a battery and showing basic components for discharging the battery, including a photocell as a light sensing circuit, an opaque pull tab, a transparent lens within a “window” opening of the battery casing, a circuit card that mounts components and includes a break-off tab, and the battery cells, such as lithium cells.

FIG. 2 is a high level block diagram showing basic components used in an apparatus for discharging the battery pack.

FIG. 3 is a schematic circuit diagram of the battery discharge circuit and light sensing circuit.

FIG. 4 is a schematic circuit diagram of one example of a battery heater circuit.

FIGS. 5 and 6 are two different schematic circuit diagrams of examples of a charge protection circuit using a field effect transistor.

FIG. 7 is a schematic circuit diagram of a flying cell circuit using an extra series, tier of cells that are switched into service when the battery voltage falls to near the minimum cut-off voltage, and are switched out of service when the battery voltage rises to near the open circuit voltage.

FIG. 8 is a schematic circuit diagram of a system for detecting a reversed battery cell in a battery pack that uses a transistor in each series cell string to determine the reversed cell condition, in accordance with one aspect of the present invention.

FIG. 9 is a schematic circuit diagram showing another embodiment of the present invention that detects a reversed battery cell in a battery pack.

FIG. 10 is a schematic circuit diagram showing a third embodiment of the present invention that detects a reversed battery cell in a battery pack.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, and prime notation is used to indicate similar elements in alternative embodiments.

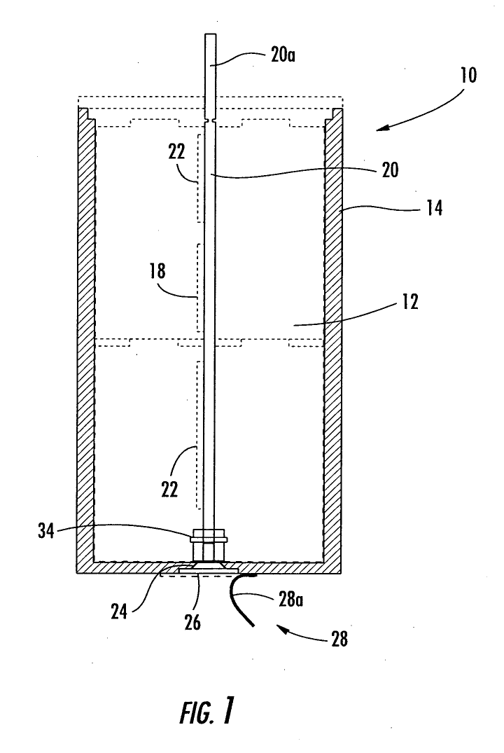

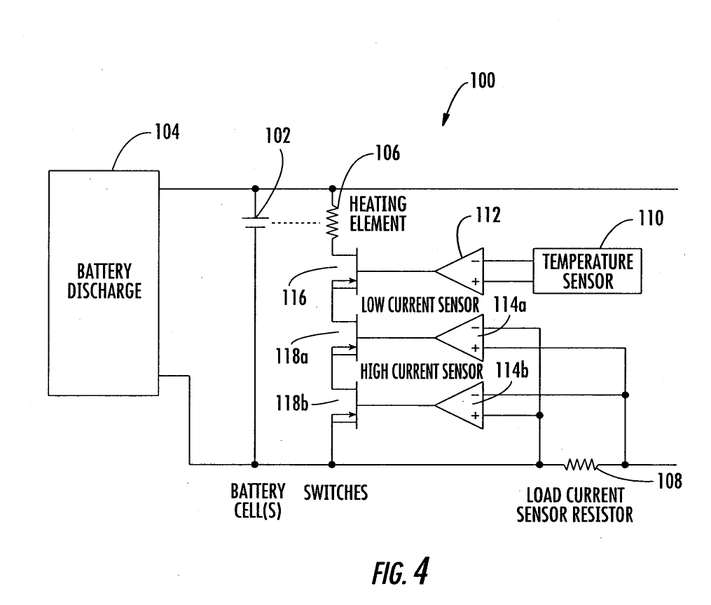

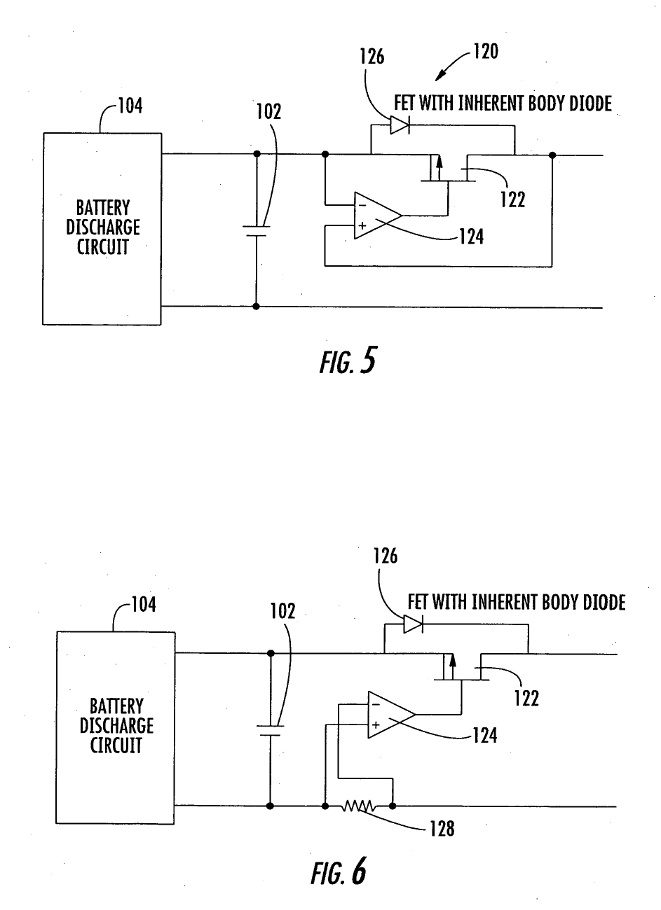

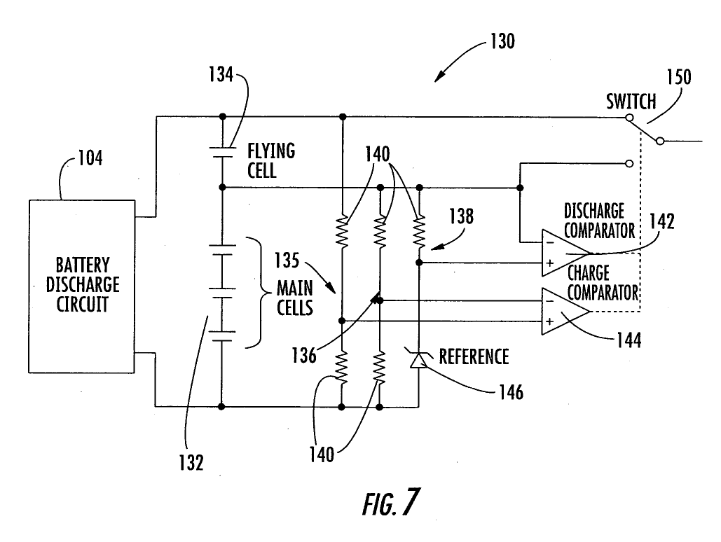

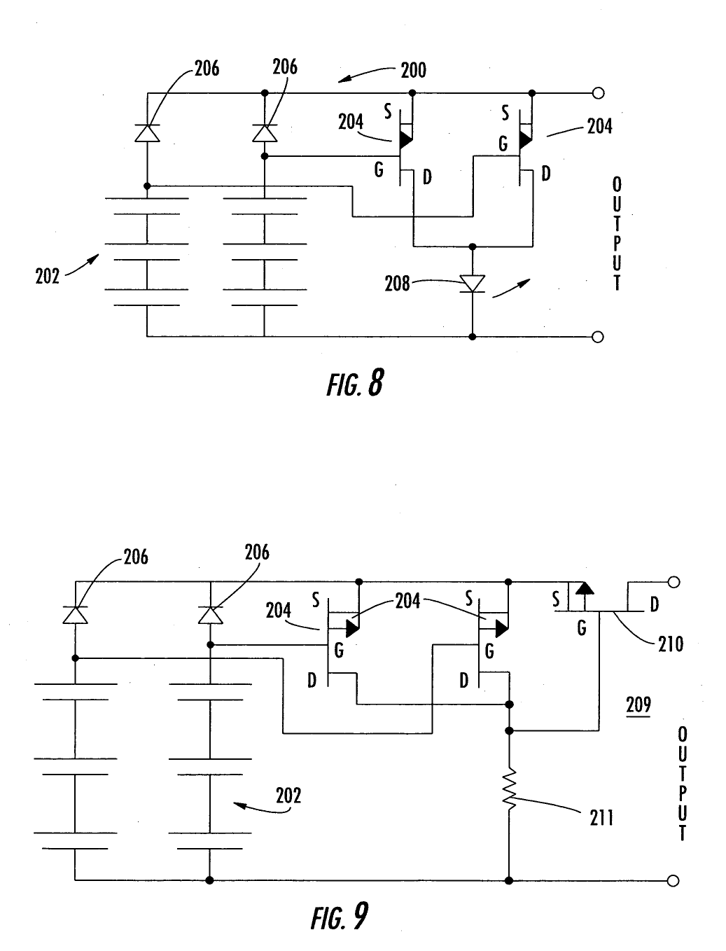

For purposes of description and background, battery discharge circuits disclosed in commonly assigned U.S. patent application Ser. Nos. 10/452,738 and 10/694,635 (the respective '738 and '635 applications) will be set forth relative to FIGS. 1-7 as examples of the types of circuits and cells that advantageously could be combined for use with the present invention. After describing in detail a battery discharge circuit relative to FIGS. 1-3, a description of other circuits that could operate in conjunction with the battery discharge circuit will be set forth in detail relative to FIGS. 4-7. An example of a battery heater circuit is shown in FIG. 4. Two examples of a charge protection circuit using a field effect transistor are shown in FIGS. 5 and 6. An example of a flying cell circuit is shown in FIG. 7. There then follows a description of an example of the reversed cell detection circuit of the present invention, relative to FIGS. 8, 9 and 10.

As a non-limiting example, the circuit of the present invention can use a single transistor (FET) in each series cell string in a series/parallel battery pack, also referred to in this description as a battery. Each transistor source is tied to the battery output and each transistor gate is tied to the series string voltage before the diode. The transistor drains are tied together and drive a LED. If any series string voltage is lower than the battery output by about a volt (as would be the case with a reversed cell), then that transistor turns on, lighting the LED.

The lit LED is clearly visible during manufacturing, especially at the final assembly stage when the battery pack is closed or placed into its case. This alerts the operator to the problem.

In an alternate embodiment, a power switch circuit uses a single transistor in each series cell string. Each transistor source is tied to the battery output and each transistor gate is tied to the series string voltage before the diode. The transistor drains are tied together and drive an additional transistor in the battery output. If any series string voltage is lower than the battery output by about a volt, as would be the case with a reversed cell, then that transistor turns on and turns off the additional transistor, disconnecting the battery from the output terminal. It is possible that instead of placing a transistor in the battery output, a transistor could be placed in each series cell string. In the event of a reversed cell, only the series string that contains the reversed cell would be disconnected, allowing the remaining series strings to deliver power to the load.

The LED circuit described above could also be used in conjunction with the power switch circuit to provide a visual indication of the reversed cell during the manufacture of the battery. This approach prevents the battery from being discharged when a cell is reversed thereby preventing the reversed cell from being charged during battery discharge. A voltage divider could be connected in parallel to a series string and operative with an LED to indicate a reversed battery cell.

There will now follow a description of the circuits disclosed in the '738 and '635 applications.

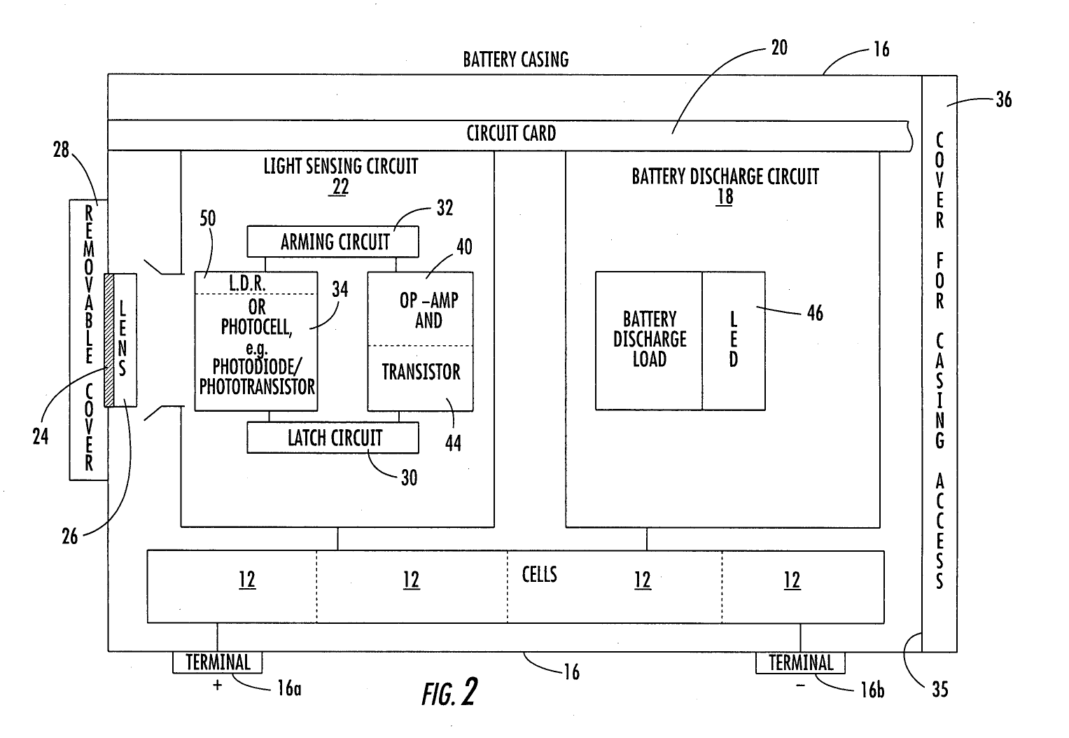

As shown in FIGS. 1 and 2, an apparatus for discharging a battery is shown, and includes a battery (a primary or rechargeable), for example, a lithium battery as a non-limiting example, having a number of battery cells 12 contained within a battery casing 16. The battery casing 16 includes positive and negative terminals 16a, 16b, which interconnect the battery cells 12. A battery discharge circuit 18 is contained within the battery casing 16, such that when actuated, discharges the battery, and more particularly, the battery cells 12.

The battery discharge circuit 18 is formed on a circuit card 20 that is positioned in a medial portion of the battery casing 16, as a non-limiting example. A light sensing circuit 22 is operatively connected to the battery discharge circuit 18 and actuates the battery discharge circuit 18 after exposing to light the light sensing circuit. This circuit 22 also can be formed on the circuit card 20. The battery casing 16 preferably includes an opening 24 that forms a “window” for exposing the light sensing circuit 22 to light. This opening 24 preferably includes a lens 26, such as a transparent or substantially translucent lens, which can be formed from glass, plastic or other material known to those skilled in the art.

The lens 26 is positioned within the opening 24 and sealed to form a watertight barrier to moisture and water. A removable and opaque cover 28 is positioned over the opening 24 and lens 26 to block light from passing onto the light sensing circuit until the cover is removed. In one aspect of the present invention, the opaque cover 28 could be a label or opaque, pull tab 28a (FIG. 1) that is adhesively secured to the battery casing and over the lens. Once the cover or tab 28, 28a is pulled from the casing, ambient light passes through the lens 26, through the opening 24, and onto the light sensing circuit 22 to actuate the battery discharge circuit 18.

As noted before, the lens 26 is preferably mounted in the opening 24 in a watertight seal to prevent water from seeping into the battery casing 16 and creating a fire hazard or explosion by contacting any lithium or other hazardous cells that have not been completely discharged. It should be understood that the watertight seal is provided by the lens 26 with the battery casing 16 and not by any pull tab, label or other cover 28 that is positioned over the opening.

Preferably the light sensing circuit 22 includes a latch circuit 30 that latches the battery discharge circuit 18 into an ON condition to maintain battery discharge even when the light sensing circuit is no longer exposed to light. A non-latching circuit could be used, but the light sensing circuit would require continual exposure of light to fully discharge the battery. Thus, with the latching circuit, the battery can be placed in a position such that light initially exposes the light sensing circuit 22. The light source can be removed while the battery maintains its discharge process.

An arming circuit 32 can be provided that arms the light sensing circuit 22 for operation after battery assembly. Thus, during the initial manufacturing process, the light sensing circuit 22 and battery discharge circuit 18 are disarmed and not operable. Any exposure of the light sensing circuit 22 to light will not activate the battery discharge circuit 18. At final assembly, however, the light sensing circuit, such as a light sensor, for example, a photocell 34 (FIG. 1), can be installed in the battery casing through a casing opening 35 and the opaque label placed over the lens 26 positioned in the opening 24 or “window.” When the circuit is armed, a casing cover or lid 36 can be attached and sealed to the battery casing. This arming circuit could be formed as a simple switch, a removable jumper connection, or printed circuit card, break-off tab 20a (FIG. 1), which once broken off, would allow the casing cover 36 to be placed thereon.

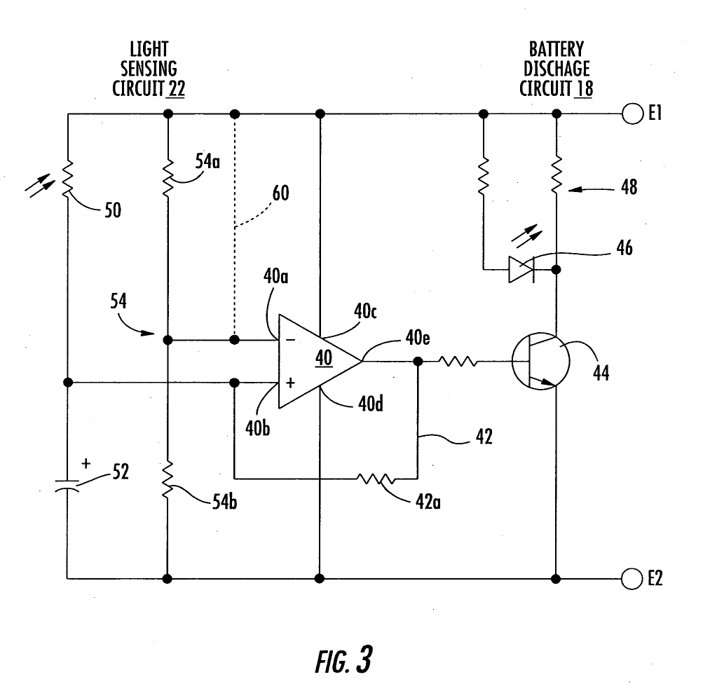

FIG. 3 shows an example of one type of circuit, as a non-limiting example, which could be used for the battery discharge apparatus. As illustrated, an operational amplifier 40 as a differentiator or similar circuit is operatively connected to the battery cell(s) with appropriate terminals labeled E1 and E2 having a potential difference therebetween for positive and negative values. The operational amplifier 40 includes the inverting input terminal 40a and the non-inverting input terminal 40b, appropriate voltage supply terminals 40c, 40d and an output terminal 40c. As illustrated, the operational amplifier 40 has a positive feedback loop circuit 42 and loopback resistor 42a that increases output and allows the operational amplifier to drive harder to saturation. The operational amplifier 40 switches state to turn on a transistor 44 acting as a switch, such as the illustrated NPN transistor, which connects to a light emitting diode 46 and resistor circuit having a resistor network 48 also forming a battery discharge load to allow discharge of the battery or battery cell. The light emitting diode 46 also emits light and acts as a visual indication of activation and could be used for battery discharge.

The light sensing circuit 22 includes a light dependent resistor 50, as a non-limiting example, which can be formed such as by cadmium sulfide or other resistor material. The light dependent resistor 50 has a resistance value that decreases when exposed to light. The light dependent resistor 50 is operatively connected in series to a capacitor 52. Both the resistor 50 and capacitor are parallel with a voltage divider circuit 54 having two resistors 54a, 56b to provide a voltage divided input to the inverting input terminal 40a. The capacitor 52 could be designed with circuit components to provide some low pass or other filtering function. It also provides momentary disarm when initially connecting to the battery. When transistor 44 is switched ON, in conjunction with the switched state of the operational amplifier, the discharge of cells remains even though the resistor 50 is no longer exposed to light. The light dependent resistor 50 and capacitor 52 also form a divider circuit that provides the input to the non-inverting input terminal 50b, which as noted before, receives the positive feedback from the output terminal 40c.

In this particular example, the arming circuit 32 is illustrated as a jumper line 60 and provides a current flow direct to the inverting input terminal 40a such that even when the operational amplifier 40, transistor 44, and overall battery discharge circuit 18 are connected to the battery cells, if the light dependent resistor 50 is exposed to light, and the resistance of the light dependent resistor drops, the jumper line 60 as illustrated provides a “short” to the inverting input terminal 40a such that the operational amplifier would not saturate and switch operating states. Thus, the operational amplifier would not bias the transistor ON to actuate the battery discharge circuit and operate the light emitting diode and thus allow discharge of the battery. This jumper line 60 could be formed as part of the circuit card 20 on the tab 20a, as shown in FIG. 1, such that before the battery casing cover 36 is placed on the battery casing, the breakable tab 20a formed on the circuit card 20 is broken to break the circuit line connection, as illustrated, and arm the circuit.

FIGS. 4-7 indicate other circuits that can be used in combination with the battery discharge circuit as described relative to FIGS. 1-3 and with the reversed cell detection circuits of the present invention shown in FIGS. 8-10. A battery heater circuit is shown in FIG. 4 and two examples of a charge protection circuit using a field effect transistor are shown in FIGS. 5 and 6. An example of a flying cell circuit is shown in FIG. 7. The reference numerals begin in the 100 series for the description relative to FIGS. 4-7.

FIG. 4 is a schematic circuit diagram of one example of a battery heating circuit 100 and shows a battery formed by one or more battery cells 102 operatively connected to a battery discharge apparatus or circuit 104, such as the battery discharge circuit described relative to FIGS. 1-3. The battery heating circuit 100 overcomes the problem where a cell or battery has a minimum operating voltage for the “cut-off voltage” and, at lower temperatures, any powered equipment reaches its cut-off voltage prematurely while the cell or battery has remaining stored capacity.

The battery heating circuit 100 can typically be included within a battery casing together with the battery discharge circuit 104 and any battery cells and includes a heating element 106, a load current sensor 108, and a temperature sensor 110 connected to a first operational amplifier operable as a comparator (op amp) 112. The load current sensor 108 is connected to a second comparator circuit formed as a low current sensor op amp 114a and high current op amp 114b. Each op amp 114a, 114b has its output connected to a respective switch 118a, 118b, each formed as a field effect transistor in this illustrated embodiment. Although two op amps 114a, 114b are illustrated, it should be understood that one or more than two op amps could be used in parallel with the first op amp 112.

The temperature sensor 112 senses temperature when the cell or battery temperature is below the temperature where available capacity is limited, such as 10° C. above the minimum specified operating temperature of the cell. The temperature sensor 110 is operative with the first op amp 112 to turn on the internal battery heater by providing power to the heating element 106 that is also operatively connected to battery cells 102 for power. This raises the temperature sufficiently such that the battery can deliver most of its rated capacity.

The load current sensor 108 is typically formed as a resistor, but other devices could be used. The sensor 108 is operative with the circuit to lock out the heating element 106 via the op amps 114a, 114b when the battery cell is not in use to prevent the heating element from discharging the battery when stored at cold temperatures. Op amps 114a, 114b are operable with the serially connected switches 116, 118a, 118b to lock out the heating element. As illustrated, op amps 112, 114a, 114b are connected to respective switches 116, 118a, 118b, each formed in this non-limiting example as a field effect transistor (FET) and operative as switches and connected to the output of the op amps 112, 114a, 114b.

The temperature sensor 110 is connected to both the inverting and non-inverting inputs of the op amp 112. When the temperature is below the temperature where available capacity is limited, the output of the op amp 112 causes the switch 116 to turn on the heating element 106. When the switch 116 is a field effect transistor (FET), it switches “ON” to provide power to the heating element.

The low current sensor and high current sensor op amps 114, 118a, 118b have their inverting and non-inverting inputs connected on either side of the load current sensor 108 formed in this example as a resistor to determine the voltage drop across the resistor. The outputs from at least one of the op amps 118a, 118b turns on a switch 118a, 118b, which in turn, would allow the heating element 102 to be switched “OFF” or “ON” as desired in conjunction with temperature sensor 110 and switch 116.

The battery could be required to deliver high energy, short duration discharge pulses. A load current sensor or other sensor could be operative to turn off the heating element when the discharge current is high. It could also ensure that available energy from the battery will be delivered to the load during periods of peak demand. The temperature sensor could be many different types of temperature sensors chosen by one skilled in the art.

Also, the battery discharge circuit 100 could include various sensors for locking out the heating element when the battery is not in use and turning off the heating element when a discharge current is high. The circuit of FIG. 4 could be modified for different types of battery cells and circuits.

FIGS. 5 and 6 illustrate a charge protection circuit 120 that uses a field effect transistor (FET) 122 and an operational amplifier 124 to sense current through the FET by measuring a voltage drop. In an acquiescent state, the op amp 124 senses no voltage across the FET (no current through it) and biases the FET off. The FET in both FIGS. 5 and 6 has an inherent body diode 126, as illustrated. Two different circuits as non-limiting examples are shown in FIGS. 5 and 6. Common elements in both circuit examples for FIGS. 5 and 6 use common reference numerals. Both FIGS. 5 and 6 show the battery discharge circuit 104 and battery cell(s) 102 in parallel with the battery discharge circuit 120. These circuits would typically be all contained within a battery casing. The operational amplifier 124 in both FIGS. 5 and 6 has an output connected to the input of the field effect transistor 122, which operates as a switch. In both examples of FIGS. 5 and 6, an inherent body diode 126 is connected to and in parallel to the source and drain of the field effect transistor 122, as illustrated.

In FIG. 5, the non-inverting input of the op amp 124 is connected to the field effect transistor 122 at its output in a feedback loop configuration. The inverting input is operatively connected to the at least one battery cell 102 and field effect transistor 122, as illustrated.

In FIG. 6, the non-inverting and the inverting inputs of the op amp 124 are connected to a resistor 128 connected to battery cell 102. The resistor is operative as a load sensor, thus allowing the op amp 124 to measure the voltage drop developed across the resistor, which is connected to the battery cell(s) 102 (and discharge circuit 104) as illustrated. The circuits of FIGS. 5 and 6 also allow charge protection diode replacement.

FIG. 7 is a schematic circuit diagram of a flying cell battery circuit 130 that overcomes the problem where typical battery applications include two voltage limits that a battery must meet, as described above. In this type of arrangement, there is an open circuit voltage that must not be exceeded, or damage to a load could occur. There is also a minimum operating or cut-off voltage that must be maintained, or the load may not function. Because of internal resistance of the cells in a battery, the cell voltage drops significantly as a load is applied. This is aggravated at colder temperatures.

In some proposals, the voltage requirements have been met by stacking as many series cells as possible without exceeding the open circuit voltage and adding as many parallel strings of cells as required to meet the cut-off voltage under the battery load and temperature operating requirements. This approach is effective and normally requires adding more cells than would normally be required. Besides adding weight and cost, this approach will not fit some physical space limitations.

An alternative approach has been the use of voltage regulation circuitry such as DC-to-DC converters. This approach is an improvement over adding parallel strings of cells, but it is costly, complex, and tends to be energy inefficient.

The flying cell circuit 130 shown in FIG. 7 overcomes these shortcomings. It uses an extra tier of cells that is switched in when the battery voltage falls to near the minimum cut-off voltage and is switched out when the battery voltage rises near the open circuit voltage. As a result, the open circuit and cut-off voltage requirements may be met over a wide range of load currents and operating temperatures with a minimum number of cells, minimum complexity, and maximum energy efficiency.

For rechargeable batteries, additional circuitry can be used to ensure proper charging. The voltage of the flying cell is sensed and compared to the individual voltages of the standard or main cells. When the voltage of the individual main cells is lower than that of the flying cell (normally the case as the flying cell is in circuit only a portion of the total discharge time), the switching circuit connects the charger to the main cells. When the voltage of the individual main cells rises to equal that of the flying cell, the switching circuit connects the charger to the series combination of main cells and the flying cell.

As shown in FIG. 7, the main and fly cells 132, 134 are serially connected. The battery discharge circuit 104 is connected to the main cells 132 and a flying cell 134 in a parallel connection. The flying cell 134 could be a single or plurality of cells. First, second and third voltage divider circuits 135, 136, 138 include resistors 140 chosen for providing desired voltage drops. First and second voltage divider circuits 135, 136 are connected to a charge comparator 144 and the third voltage divider circuit 138 is connected to the discharge comparator 142. The first voltage divider circuit 135 connects to the non-inverting input and the second voltage divider circuit 136 connected to the inverting input of charge comparator. The third voltage divider circuit 138 is connected to the non-inverting input of the discharge comparator 142. The third voltage divider circuit 138 is operative with a reference 146, shown as a Zener diode in this one non-limiting example. The inverting input of the discharge comparator 142 is connected to a first terminal of a pole switch 150. The flying cell 134 and the first voltage divider circuit 134 is also connected. The output of the discharge and charge comparators 142, 144 are connected to the switch 150 as illustrated. The main cells 132 are connected to the other terminal of the switch 150, as are second and third voltage divider circuits 136, 138 and inverting input of op amp 142.

The discharge comparator 142 and charge comparator 144 compare the battery voltage when it falls to near the minimum cut-off voltage and allows the extra tier of cells as a flying cell to be switched in when the battery voltage falls to this near minimum cut-off voltage that could be established as desired by those skilled in the art. It is switched out when the battery voltage rises near the open circuit voltage. The voltage on the flying cell is sensed and compared to the individual voltages of the standard main cells 132. When the voltage of the individual main cells 132 is lower than that of the flying cell 134, the switching circuit 150 connects the charger to the main cells. When the voltage of the individual main cells 132 rises to equal that of the flying cell, the switching circuit 150 connects the charger to the series combination of main cells and the flying cell.

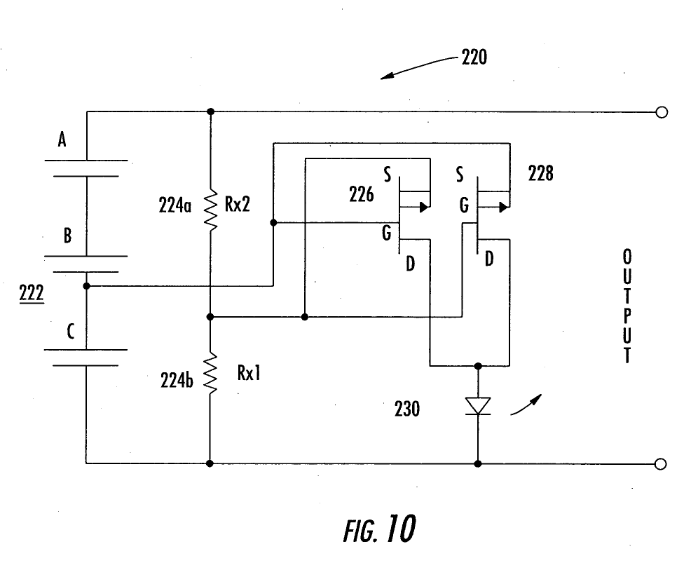

As shown in FIGS. 8 and 9, a reversed cell detection circuit of the present invention is illustrated with respect to battery packs formed from series/parallel combinations, for example, the three series battery cells configured in two parallel series strings as non-limiting examples. FIG. 8 illustrates a first embodiment. A second embodiment is shown in FIG. 9. The embodiments of FIGS. 8 and 9 are shown with series/parallel combinations of battery cells. A third embodiment is shown in FIG. 10 and shows use of a voltage divider. Each circuit example can include a single transistor (FET) in each series cell string shown in parallel with each other in FIGS. 8 and 9.

FIG. 8 shows a system 200 of the present invention with a battery pack 202 formed by two parallel columns of series connected battery cells. Three cells are shown in each series string. More than two parallel battery cell strings can be used, of course, and more than three series connected battery cells per string can be used. A single transistor, preferably a Field Effect transistor (FET) 204, is connected in each series cell string. Each transistor source (S) is tied to the battery output and each transistor gate (G) is tied to the series string voltage before a series diode 206, as illustrated. The transistor drains (D) are tied together and drive a LED 208. If any series string voltage is lower than the battery output by about a volt, for example, in this non-limiting example, as would be the case with a reversed battery cell, then that transistor turns on and lights the LED 208.

The lit LED 208 is clearly visible during manufacturing, especially at the final assembly stage when the battery pack is being closed or placed into its case. This alerts the operator to the problem.

In an alternate embodiment shown in FIG. 9, a power switch circuit 209 uses a single transistor (FET) 204a in each series cell string. Each transistor source (S) is tied to the battery output and each transistor gate (G) is tied to the series string voltage before the diode 206. The transistor drains (D) are tied together and drive an additional transistor, such as an FET 210, in the battery output. A resistor 211 is selected for proper biasing on the gate (G) of FET transistor 210. If any series string voltage is lower than the battery output by about a volt, as would be the case with a reversed battery cell, then that transistor turns on, turning off the additional FET, disconnecting the battery cell from the output terminal. If so desired, instead of placing a FET in the battery output, one FET could be placed in each series cell string. In the event of a reversed battery cell, only the series string that contains the reversed battery cell would be disconnected, thereby allowing the remaining series strings to deliver power to the load.

Also, the LED circuit described above could be used in conjunction with the power switch circuit 209 to provide a visual indication of the reversed cell during manufacturing of the battery. This approach prevents the battery from being discharged when a cell is reversed thereby preventing the reversed cell from being charged during battery discharge.

FIG. 10 is a schematic circuit diagram of a third embodiment of the present invention and showing a system 220 that is operative with a series string of battery cells 222, listed as A, B and C in this non-limiting example. A series voltage divider is formed from two series connected resistors 224a, 224b and connected parallel between the battery cells. A first transistor 226 is connected into the series strings of battery cells at its gate and a second transistor 228 is connected at its gate to the voltage divider between the two resistors 224a, 224b. Drains are connected together and operative with a light emitting diode 230. The source of transistor 228 connects to the battery cells and the source of the transistor 226 connects to the voltage divider.

The voltage divider formed by resistors 224a, 224b is of the proper ratio such that the divided voltage is equal to the voltage at a point in the series strings of cells when the cells are connected properly. This circuit can detect an unequal voltage condition. If cell C is reversed, the voltage at the source of transistor 228 would be lower than the voltage at the gate of transistor 228, thereby turning on the transistor and lighting the light emitting diode 230. If either cell A or B were reversed, the voltage at the gate of transistor 226 would be lower than the voltage at the source of transistor 226, thereby turning on transistor 226 and lighting the LED. Although it is illustrated with a single series string of cells having no parallel branches, the system could be used with a battery pack formed of both series/parallel cells.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

1. A system for detecting a reversed battery cell within a battery pack comprising:
a plurality of battery cells connected together and forming a battery pack having a battery output;
a transistor circuit operatively connected to the battery cells and operative for determining when a voltage condition occurs indicative of a reversed battery cell within the battery pack; and
an indication circuit operatively connected to the transistor circuit for indicating a reversed battery cell within the battery pack.

2. A system according to claim 1, wherein said transistor circuit comprises a plurality of transistors, each having a drain connected to said indicator circuit, a source connected to said battery output, and a gate operatively connected to the battery cells.

3. A system according to claim 2, wherein said transistors comprise Field Effect Transistors.

4. A system according to claim 1, wherein said indication circuit comprises a Light Emitting Diode (LED) to provide a visual indication of a reversed battery cell.

5. A system according to claim 1, wherein said indication circuit comprises a power switch circuit.

6. A system according to claim 5, wherein said power switch circuit comprises a transistor connected to the battery output and operative for disconnecting a plurality of battery cells from the battery output.

7. A system according to claim 1, wherein said plurality of battery cells are connected together in a series string.

8. A system according to claim 7, and further comprising a voltage divider circuit operatively connected to said plurality of battery cells and having a divide ratio such that any divided voltage is equal at a point in the series string of battery cells when the battery cells are connected properly.

9. A system according to claim 1, wherein said plurality of battery cells are connected together in a plurality of parallel, series strings.

10. A system according to claim 9, and further comprising a transistor connected into each series string of battery cells and operative for detecting a reversed battery cell within a series string and disconnecting from the battery output the series string of battery cells having the reversed battery cell.

11. A system for detecting a reversed battery cell within a battery pack comprising:
a plurality of battery cells connected together in a plurality of parallel, series strings of battery cells and forming a battery pack having a battery output;
a series diode connected into each series string;
a transistor connected to each series string before the diode, said transistors connected together and operative for determining when a voltage condition occurs indicative of a reversed battery cell within the battery pack; and
an indication circuit operatively connected to each transistor for indicating a reversed battery cell condition.

12. A system according to claim 11, wherein each transistor includes a drain connected to said indicator circuit, a source connected to said battery output, and a gate operatively connected to the battery cells.

13. A system according to claim 11, wherein said indication circuit comprises a Light Emitting Diode (LED) to provide a visual indication of a reversed cell.

14. A system according to claim 11, wherein said indication circuit comprises a power switch circuit.

15. A system according to claim 14, wherein said power switch circuit comprises a transistor connected to the battery output and operative for disconnecting a plurality of battery cells from the battery output.

16. A system according to claim 11, and further comprising a voltage divider circuit operatively connected to a series string of battery cells and having a ratio such that any divided voltage is equal at a point in the series string of battery cells when the battery cells are connected properly.

17. A system according to claim 11, and further comprising a transistor connected into each series string of battery cells and operative for detecting a reversed battery cell within a series string of battery cells and disconnecting from the battery output the series string of battery cells having the reversed battery cell.

18. A method of detecting a reversed battery cell within a battery pack comprising:
connecting together a plurality of battery cells to form a battery pack having a battery output;
detecting a voltage condition indicative of a reversed battery cell within the battery pack; and
indicating that a reversed battery cell exists in the battery pack.

19. A method according to claim 18, wherein the step of indicating the reversed battery cell comprises energizing a Light Emitting Diode (LED).

20. A method according to claim 18, wherein the step of indicating the reversed battery cell comprises switching ON a transistor and disconnecting a reversed battery cell from the battery output.
